(19) United States
(12) Patent Application Publication
(10) Pub. No.: US 2026/0001249 A1
(43) Pub. Date: Jan. 1, 2026

(54) DIAMETER-WIRE DICING MACHINE

(71) Applicant: MICRON DIAMOND WIRE & EQUIPMENT CO., LTD., New Taipei City (TW)

(72) Inventor: Cheng-Ming LEE, New Taipei City (TW)

(21) Appl. No.: 18/909,966

(22) Filed: Oct. 9, 2024

(30) Foreign Application Priority Data
Jun. 27, 2024 (TW) 113206816

(51) Int. Cl. B26D 1/547; B26D 1/00; B26D 7/01

(52) U.S. Cl. CPC B26D 1/547; B26D 1/0006; B26D 7/018; B26D 2001/0013; B26D 2001/002

(57) ABSTRACT

A diamond-wire dicing machine includes a machine chassis, which includes a bottom support. A base extends upwards from the bottom support. A plurality of tension regulation arms are arranged on the base and are each provided with a tension roller. A plurality of guide rollers are also arranged on the base. The tension rollers and the guide rollers are spaced from each other. A plurality of wire winding/releasing devices are respectively arranged at two sides of the base and are each provided with a wire winding/unwinding wheel. A diamond wire extends through the tension rollers, the guide rollers, and the wire winding/unwinding wheels, and the surface of the diamond wire is provided with diamond particles. The wire winding/releasing devices are operable to take up and release the diamond wire for reciprocally moving the diamond wire to bring new ones of the diamond particles to contact and cut a wafer.

### BACKGROUND OF THE INVENTION

### (a) Technical Field of the Invention

The present invention relates generally to a dicing machine, and more particularly to a diamond-wire dicing machine.

### (b) Description of the Prior Art

In the semiconductor manufacturing process, wafer dicing is the process of separating bare dies from a large wafer to make small chips. A large wafer can produce multiple identical or similar chips to enhance the production efficiency. After the wafer is cut, individual chips are packaged on chip carriers.

Generally speaking, wafer dicing is to cut the wafer with a saw blade of a wafer dicing machine. The saw blade is the general name for thin circular cutters specifically used to cut solid materials. The saw blade is generally made of a high-precision rigid alloy material (such as diamond) and is rotatable at a high speed for performing cutting. The saw blade can easily cause chips and gouges formed in a cut edge of the wafer, or even cause cracks. Moreover, the saw blade will also become dull due to long-term cutting wear, resulting in a decrease in precision during the cutting process.

Prior art technology is known, such as Taiwan Utility Model M582228, which discloses a “precision diamond cutting machine”, which includes: a machine table; a cutter feed mechanism, the cutter feed mechanism including a lifting seat for mounting a rotary power device; the rotary power device including a rotary spindle, the rotary spindle driving a cutting tool. The rotary spindle drives the cutting tool to rotate. The lifting seat is reciprocally movable along at least two lifting sliding axes, so as to have the cutting tool reciprocate vertically along the machine table to perform a cutter feeding stroke and a position returning stroke. However, referring to FIG. 4 of the utility model M582228, during cutting, since the cutting tool (i.e., the saw blade) is driven to rotate and performs the cutter feeding stroke and the position returning stroke with vertical reciprocating movement, diamond particles on the cutting tool are easily worn out over time, affecting the stability and consistency of the cutting process.

### SUMMARY OF THE INVENTION

To achieve the above objective, the present invention provides a diamond-wire dicing machine, which comprises: a machine chassis, wherein the machine chassis comprises a bottom support, a base extending upwards from the bottom support; a plurality of tension regulation arms being arranged on the base, the plurality of tension regulation arms being each provided with a tension roller, a plurality of guide rollers being arranged on the base, the plurality of tension rollers being spaced from the plurality of guide rollers; a plurality of wire winding/releasing devices, wherein the plurality of wire winding/releasing devices are respectively arranged at two sides of the base, the plurality of wire winding/releasing devices being each provided with a wire winding/unwinding wheel; and a diamond wire, wherein the diamond wire extends through the plurality of tension rollers, the plurality of guide rollers, and the plurality of wire winding/unwinding wheels, and a surface of the diamond wire is provided with a plurality of diamond particles.

In the present invention, each of the wire winding/releasing devices comprises a wire winding/unwinding shaft and a power device, and the wire winding/unwinding wheel is mounted by the wire winding/unwinding shaft to the power device, so as to set the wire winding/unwinding wheel in a rotatable condition, the power device driving the wire winding/unwinding shaft to operate.

The present invention may further comprise a wafer holding device and a detecting device, and the wafer holding device is arranged on the bottom support and the detecting device is arranged on the base.

In the present invention, the wafer holding device comprises a wafer table, a wafer support, and a drive device, the wafer table being connected to the wafer support, the wafer support being arranged between the wafer table and the drive device, the drive device driving the wafer support to drive the wafer table to move relative to the machine chassis.

In the present invention, the wafer table of the wafer holding device comprises a vacuum suction cup.

In the present invention, the detecting device comprises a charge-coupled device (CCD) camera.

As such, the present invention uses the plurality of wire winding/releasing devices to take up and release the diamond wire to make the diamond wire reciprocally moved for cutting and dicing the wafer. As the reciprocal movement of the diamond wire repeatedly brings new ones of the diamond particles to contact the wafer, so that wear is extremely lowered to thereby help keep stability and consistency during the cutting process.

### BRIEF DESCRIPTION OF THE DRAWINGS

FIG. 1 is a schematic vie showing a diamond-wire dicing machine according to the present invention.

FIG. 2 is a schematic view showing a first portion of the diamond-wire dicing machine according to the present invention.

FIG. 3 is a schematic view showing a second portion of the diamond-wire dicing machine according to the present invention.

FIG. 4 is a side elevational view showing the diamond-wire dicing machine according to the present invention.

FIG. 5 is a schematic view demonstrating a first operation of the diamond-wire dicing machine according to the present invention.

FIG. 6 is a schematic view demonstrating a second operation of the diamond-wire dicing machine according to the present invention.

FIG. 7 is a schematic view demonstrating a third operation of the diamond-wire dicing machine according to the present invention.

FIG. 8 is a schematic view showing a diamond wire of the present invention.

### DETAILED DESCRIPTION OF THE PREFERRED EMBODIMENTS

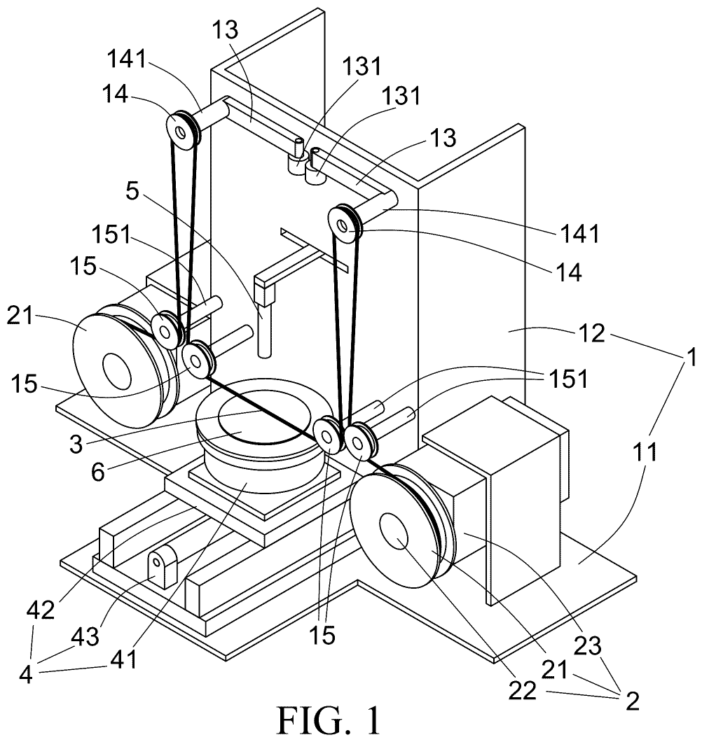

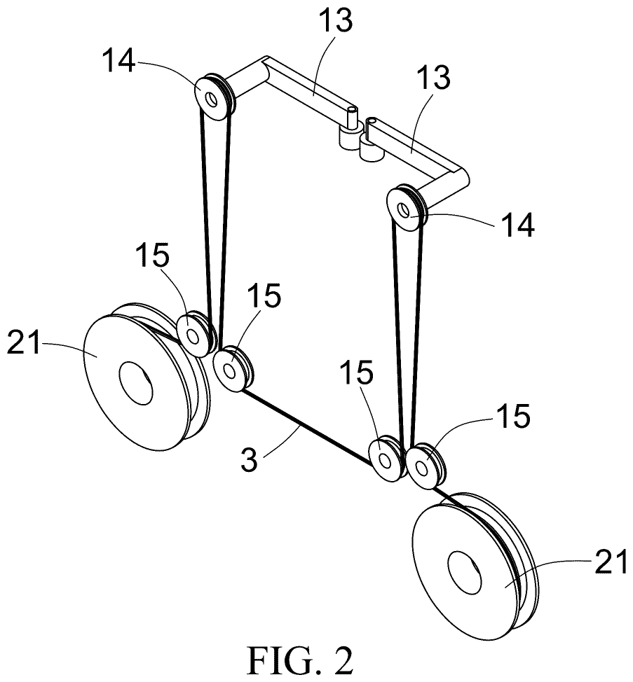

Referring to FIGS. 1 and 2, the present invention provides a diamond-wire dicing machine, which comprises: a machine chassis 1, a plurality of wire winding/releasing devices 2, and a diamond wire 3.

The machine chassis 1 comprises a bottom support 11. A base 12 extends upwards from the bottom support 11. A plurality of tension regulation arms 13 are arranged on the base 12. Each of the plurality of tension regulation arms 13 is provided with a tension roller 14. Further, a plurality of guide rollers 15 are also arranged on the base 12. The plurality of tension rollers 14 are arranged to space from the plurality of guide rollers 15.

The tension regulation arms 13 are rotatably mounted by rotation axles 131 to the base 12, and are freely rotatable about centers defined by the rotation axles 131. The tension regulation arms 13 are operable to regulate a tension of the diamond wire 3. The tension rollers 14 are mounted by rotation axles 141 on the tension regulation arms 13 respectively, so that the tension rollers 14 are each set in a rotatable condition. The guide rollers 15 are mounted by rotation axles 151 on the base 12, so that the guide rollers 15 are each set in a rotatable condition. Further, the plurality of tension roller 14 and the plurality of guide rollers 15 are respectively arranged at two ends of the base 12, so that the plurality of tension roller 14 and the plurality of guide rollers 15 are spaced from each other.

The plurality of wire winding/releasing devices 2 are respectively arranged at two sides of the base 12. The plurality of wire winding/releasing device 2 are each provided with a wire winding/unwinding wheel 21.

Each of the wire winding/releasing devices 2 comprises a wire winding/unwinding shaft 22 and a power device 23, and the wire winding/unwinding wheel 21 is mounted by the wire winding/unwinding shaft 22 to the power device 23, so that the wire winding/unwinding wheel 21 is set in a rotatable condition and the power device 23 drives the wire winding/unwinding shaft 22 to operate the wire winding/unwinding wheel 21. The power device 23 can be a motor. The wire winding/releasing devices 2 are operable to perform operations of repeatedly taking up and releasing the diamond wire 3 to thereby make the diamond wire 3 reciprocally move.

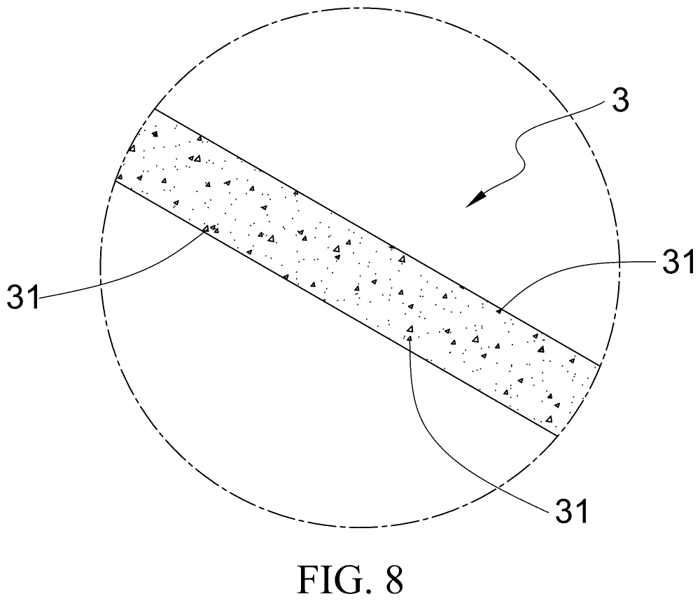

The diamond wire 3 is extended through the plurality of tension rollers 14, the plurality of guide rollers 15, and the plurality of wire winding/unwinding wheels 21. The surface of the diamond wire 3 is provided with a plurality of diamond particles 31 (shown in FIG. 8).

The diamond wire 3 is a linear cutting tool made by fixing the plurality of diamond particles 31 (shown in FIG. 8) on the surface of a steel wire through special technology.

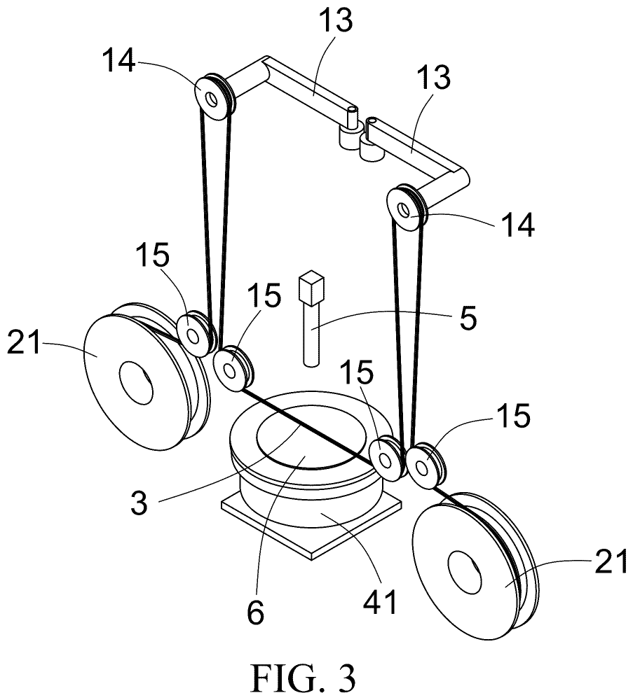

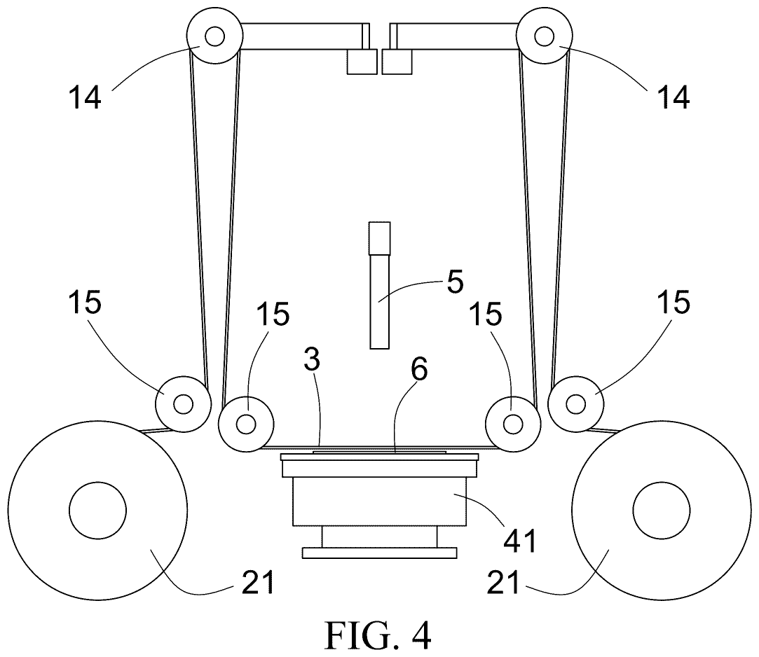

Referring to FIGS. 1, 3, and 4, the present invention further comprises a wafer holding device 4 and a detecting device 5. The wafer holding device 4 is arranged on the bottom support 11. The detecting device 5 is arranged on the base 12.

The wafer holding device 4 comprises a wafer table 41, a wafer support 42, and a drive device 43. The wafer table 41 is connected to the wafer support 42. The wafer support 42 is arranged between the wafer table 41 and the drive device 43. The drive device 43 drives the wafer support 42 to cause the wafer table 41 to operate relative to the machine chassis 1. The wafer table 41 of the wafer holding device 4 can be a vacuum suction cup that sucks and holds a wafer 6. The wafer support 42 may comprise a slide rail, an axle, or other equivalent devices to fulfill upward/downward and frontward/rearward movement or 360-degree rotation. The drive device 43 may comprises a motor, a rotation axle, a pulley, a pneumatic cylinder, or other equivalent devices to drive the wafer support 42 to operate. The detecting device 5 can be charge-coupled device (CCD) camera.

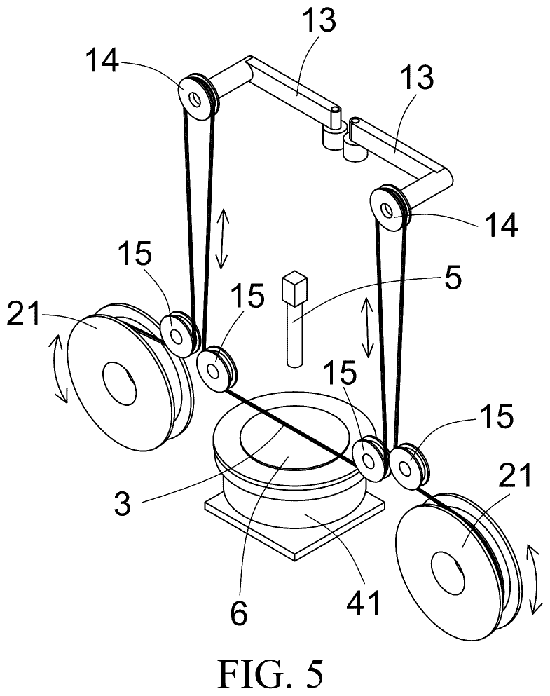

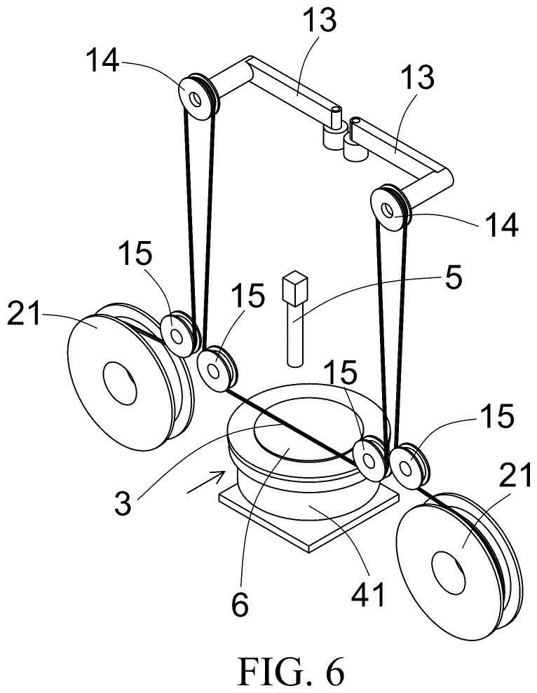

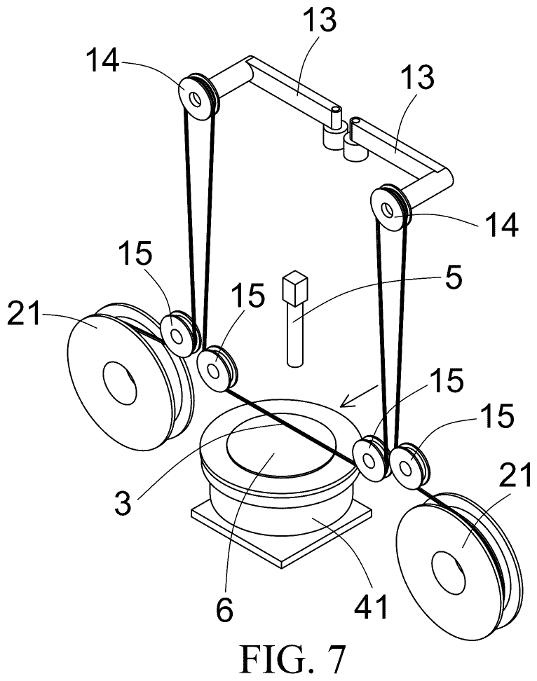

Referring to FIGS. 1 and 5, operation of the diamond-wire dicing machine according to the present invention is as follows. Before performance of dicing, the wafer 6 is placed on the wafer table 41 of the wafer holding device 4, and the detecting device 5 is operated to make the wafer 6 precisely positioned on the wafer table 41, and then, the wafer 6 is sucked and held by the wafer table 41. Afterwards, the power device 23 of each of the wire winding/releasing devices 2 drives the wire winding/unwinding shaft 22, and the wire winding/unwinding shaft 22 drives the wire winding/unwinding wheel 21 to have the wire winding/unwinding wheel 21 rotating, so that the diamond wire 3 on the wire winding/unwinding wheel 21 is unwound from one end and the diamond wire 3 is taken up at an opposite end so as to perform repeated winding and unwinding operations of the diamond wire 3, making the diamond wire 3 repeatedly moved along the tension rollers 14 and the plurality of guide rollers 15, and thus, the diamond wire 3 is moved to approach the wafer 6 held on the wafer table 41 to carry out cutting and dicing. Further, the tension regulation arms 13 are operable to rotate about the rotation axles 131 to regulate the tension of the diamond wire 3 and thus setting the diamond wire 3 in a state of proper tensioning to thereby prevent the diamond wire 3 from being broken by an excessively large tension. Further, the drive device 43 is operable to drive the wafer support 42 to move in order to cause the wafer table 41 to move relative to the machine chassis 1, such as rotating the wafer table 41 to change the direction of the wafer 6 or upwards/downwards or frontwards/rearwards moving the wafer table 41 (shown in FIGS. 6 and 7) to allow for easy cutting and dicing the wafer 6 into multiple pieces of chips.

As such, the present invention uses the plurality of wire winding/releasing devices 2 to take up and release the diamond wire 3 to make the diamond wire 3 reciprocally moved for cutting and dicing the wafer 6. As the reciprocal movement of the diamond wire 3 repeatedly brings new ones of the diamond particles 31 to contact the wafer 6, so 5 that wear is extremely lowered to thereby help keep stability and consistency during the cutting process.

I claim:

1. A diamond-wire dicing machine, comprising:
a machine chassis, wherein the machine chassis comprises a bottom support, a base extending upwards from the bottom support; a plurality of tension regulation arms being arranged on the base, the plurality of tension regulation arms being each provided with a tension roller, a plurality of guide rollers being arranged on the base, the plurality of tension rollers being spaced from the plurality of guide rollers;
a plurality of wire winding/releasing devices, wherein the plurality of wire winding/releasing devices are respectively arranged at two sides of the base, the plurality of wire winding/releasing devices being each provided with a wire winding/unwinding wheel; and
a diamond wire, wherein the diamond wire extends through the plurality of tension rollers, the plurality of guide rollers, and the plurality of wire winding/unwinding wheels, and a surface of the diamond wire is provided with a plurality of diamond particles.

2. The diamond-wire dicing machine according to claim 1, wherein each of the wire winding/releasing devices comprises a wire winding/unwinding shaft and a power device, and the wire winding/unwinding wheel is mounted by the wire winding/unwinding shaft to the power device, so as to set the wire winding/unwinding wheel in a rotatable condition, the power device driving the wire winding/unwinding shaft to operate.

3. The diamond-wire dicing machine according to claim 1, further comprising a wafer holding device and a detecting device, the wafer holding device being arranged on the bottom support, the detecting device being arranged on the base.

4. The diamond-wire dicing machine according to claim 3, wherein the wafer holding device comprises a wafer table, a wafer support, and a drive device, the wafer table being connected to the wafer support, the wafer support being arranged between the wafer table and the drive device, the drive device driving the wafer support to drive the wafer table to move relative to the machine chassis.

5. The diamond-wire dicing machine according to claim 3, wherein the wafer table of the wafer holding device comprises a vacuum suction cup.

6. The diamond-wire dicing machine according to claim 3, wherein the detecting device comprises a charge-coupled device (CCD) camera.
